(19) United States
(12) Patent Application Publication
(10) Pub. No.: US 2026/0119484 A1
(43) Pub. Date: Apr. 30, 2026

(54) INFORMATION PROCESSING APPARATUS

(71) Applicant: TOYOTA JIDOSHA KABUSHIKI KAISHA, Toyota-shi (JP)

(72) Inventor: Hideki KAWAI, Tokyo-to (JP)

(73) Assignee: TOYOTA JIDOSHA KABUSHIKI KAISHA, Toyota-shi (JP)

(21) Appl. No.: 19/352,700

(22) Filed: Oct. 8, 2025

(30) Foreign Application Priority Data
Oct. 25, 2024 (JP) 2024-188609

(51) Int. Cl. G06F 16/2452

(52) U.S. Cl. CPC G06F 16/24522

(57) ABSTRACT

An information processing apparatus includes a controller configured to register, for a plurality of vehicles, one or more attributes in a database in combination with attribute values that are values of the attributes, identify, when a question sentence written in natural language is input, a search condition indicated in the question sentence in relation to the attributes using machine learning, generate a query to select a vehicle corresponding to the identified search condition from the database, and output a result of searching the database using the query.

### CROSS-REFERENCE TO RELATED APPLICATION

This application claims priority to Japanese Patent Application No. 2024-188609 filed on October 25, 2024, the entire contents of which are incorporated herein by reference.

### TECHNICAL FIELD

The present disclosure relates to an information processing apparatus.

### BACKGROUND

Patent Literature (PTL) 1 discloses technology for selecting documents that may contain answers to a user's question input into a search model and outputting answers to the user's question.

### CITATION LIST

### Patent Literature

PTL 1: JP 2023-076413 A

### SUMMARY

There is room for improvement in technology for searching products that correspond to specific specifications from natural language question sentences.

It would be helpful to improve the technology for searching products that correspond to specific specifications from natural language question sentences.

An information processing apparatus according to an embodiment of the present disclosure includes a controller configured to: register, for a plurality of vehicles, one or more attributes in a database in combination with attribute values that are values of the attributes; identify, when a question sentence in natural language is input, a search condition indicated in the question sentence in relation to the attributes using machine learning; generate a query to select a vehicle corresponding to the identified search condition from the database; and perform control to output a result of searching the database using the query.

According to the present disclosure, the technology for searching products that correspond to specific specifications from natural language question sentences is improved.

### BRIEF DESCRIPTION OF THE DRAWINGS

In the accompanying drawings:

FIG. 1 is a block diagram illustrating a configuration of a system according to an embodiment of the present disclosure; and

FIG. 2 is a flowchart illustrating operations of an information processing apparatus according to the embodiment of the present disclosure.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified as appropriate.

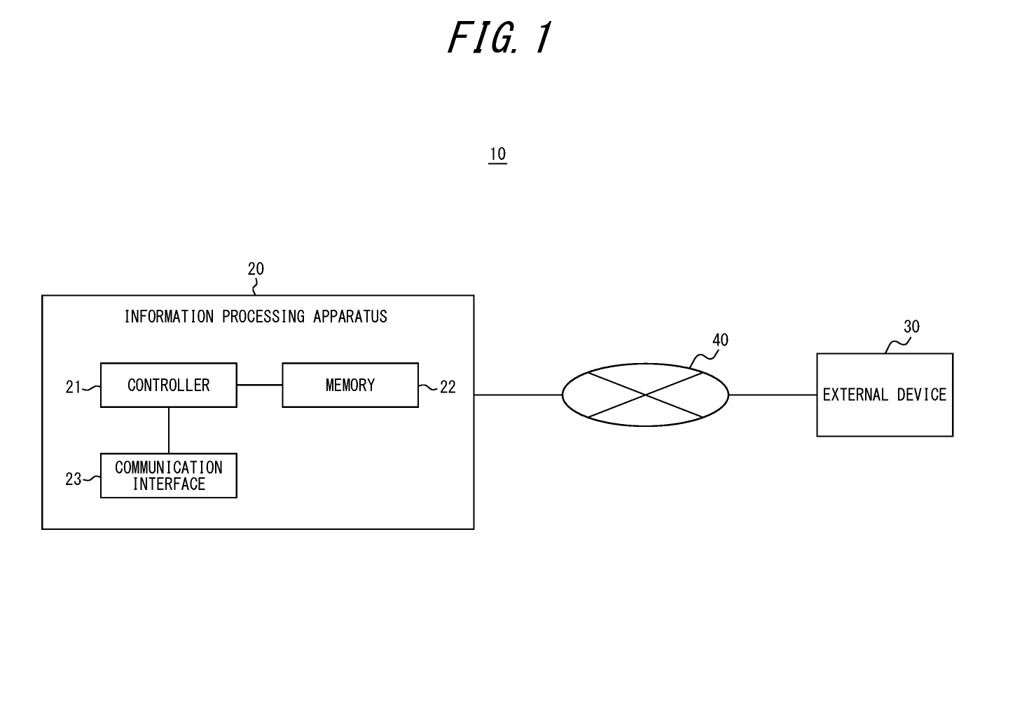

A configuration of a system 10 according to the present embodiment will be described with reference to FIG. 1.

The system 10 includes at least one information processing apparatus 20 and at least one external device 30.

The information processing apparatus 20 can communicate with the external device 30 via a network 40.

The information processing apparatus 20 is a computer such as a server that belongs to a cloud computing system or other computing system installed in a facility such as a data center.

The external device 30 is a terminal device installed at a dealership that sells vehicles. The external device 30 may, for example, be a mobile phone, a smartphone, a tablet, or a PC. The term "PC" is an abbreviation of personal computer.

The network 40 includes the Internet, at least one WAN, at least one MAN, or any combination thereof. The term "WAN" is an abbreviation of wide area network. The term "MAN" is an abbreviation of metropolitan area network.

An outline of the present embodiment will be described with reference to FIG. 1.

By using a dialogue system employing information retrieval technologies such as RAG, it is possible to answer questions inquiring about the specifications of specific vehicles by loading the vehicle specification table. "RAG" is an abbreviation for Retrieval-Augmented Generation. Using such a dialogue system, for example, during a business negotiation, it is possible to search for vehicle models that meet the conditions desired by the customer. However, when the staff as users inquire about the desired conditions in natural language question sentences, the ambiguity in the expression of the question sentences may cause the search condition expression as a query to be generated incorrectly. For example, when the customer wants to use specific numerical values for specifications such as "vehicle height," "tire outer width," and "tread width" as search conditions, the units of those values may not be spoken in actual dialogue. As a result, it was not possible to correctly identify the search conditions.

In this embodiment, the information processing apparatus 20 registers one or more attributes for multiple vehicles in a database, combining them with attribute values that are the values of the attributes. When a question sentence in natural language is input to the information processing apparatus 20, it identifies the search conditions indicated in the question sentence related to the attributes using machine learning. Any machine learning method can be used, but for example, any natural language processing technology selected from large language models, NLP, intent recognition models, NER, and semantic search can be used alone or in combination. "NLP" is an abbreviation for Natural Language Processing. "NER" is an abbreviation for Named Entity Recognition. The information processing apparatus 20 generates a query to select vehicles from the database that match the identified search conditions. The information processing apparatus 20 outputs the search results of the database based on the query.

According to this embodiment, when a question sentence in natural language is input to the information processing apparatus 20, it identifies the search conditions indicated in the question sentence related to the attributes using machine learning. For example, if the identified attribute from the question sentence is "vehicle height" and the reference value as the identified search condition related to "vehicle height" is "1.55," that reference value is corrected to "1.55m." Therefore, even if the unit of the numerical value included in the question sentence is not spoken and the question sentence contains ambiguous expressions, the search conditions can be more easily identified correctly. Thus, the technology for searching products that correspond to specific specifications from natural language question sentences is improved.

A configuration of the information processing apparatus 20 according to the present embodiment will be described with reference to FIG. 1.

The information processing apparatus 20 includes a controller 21, a memory 22, and a communication interface 23. The controller 21 includes at least one processor, at least one programmable circuit, at least one dedicated circuit, or any combination thereof, and executes predetermined processing.

The memory 22 includes at least one semiconductor memory, at least one magnetic memory, at least one optical memory, or a combination of at least two of these. The memory 22 stores data to be used in the operations of the information processing apparatus 20 and data obtained by the operations of the information processing apparatus 20. In the present embodiment, a database DB is stored in the memory 22. The database DB will be described later.

The communication interface 23 includes at least one interface for communication. The communication interface 23 receives data to be used for the operations of the information processing apparatus 20 and transmits data obtained by the operations of the information processing apparatus 20. In the present embodiment, the communication interface 23 communicates with an external device 30.

The functions of the information processing apparatus 20 are realized by execution of a program according to the present embodiment by a processor serving as the controller 21. That is, the functions of the information processing apparatus 20 are realized by software. The program causes a computer to execute the operations of the information processing apparatus 20, thereby causing the computer to function as the information processing apparatus 20. That is, the computer executes the operations of the information processing apparatus 20 in accordance with the program to thereby function as the information processing apparatus 20.

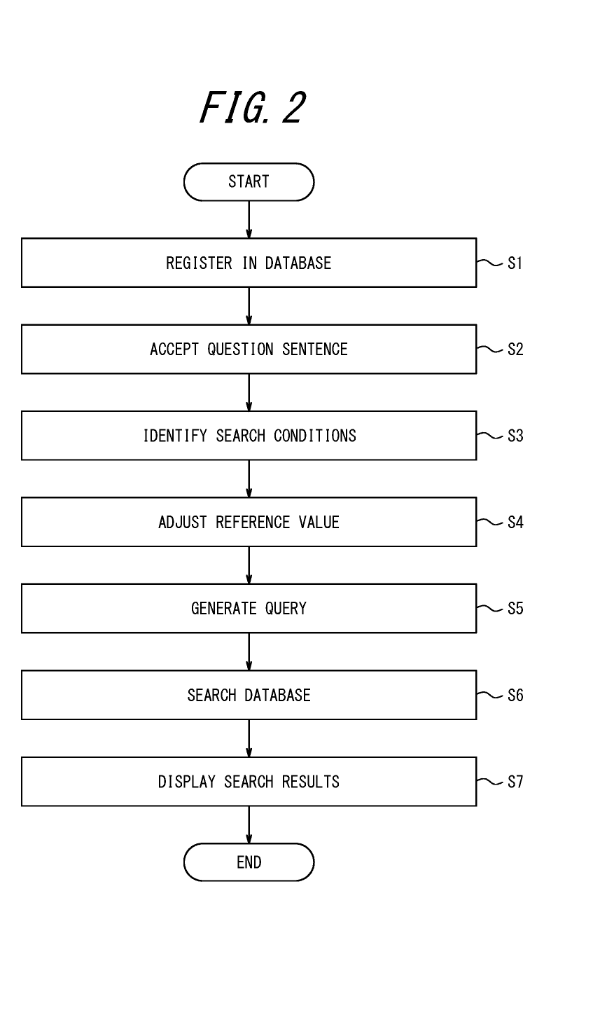

Operations of the information processing apparatus 20 according to the present embodiment will be described with reference to FIG. 2. These operations correspond to an information processing method according to the present embodiment. In other words, the information processing method according to the present embodiment includes steps S1 to S7 illustrated in FIG. 2. Hereinafter, each step of the flowchart will be identified by S and a number.

In S1, the controller 21 of the information processing apparatus 20 registers one or more attributes for multiple vehicles in the database DB, combined with attribute values that are the values of the attributes. In the present embodiment, one or more attributes include specifications of the automobile. The controller 21 can read the specifications table of multiple vehicles or refer to publicly available official information, and register the specifications of the automobile for each vehicle. The controller 21 registers attributes such as "vehicle height," "tire outer width," and "tread width" in the database DB along with their numerical attribute values, for example. The controller 21 may also calculate and register attributes and their attribute values that are not in the specifications table in the database DB. For example, one of the important constraints of a multi-story parking lot is the "tire outer width." However, the specifications table of the vehicle catalog generally does not include a description of the "tire outer width." The "tire outer width" refers to the width of the outer sides of the left and right tires of the vehicle. In this case, the controller 21 may calculate the "tire outer width" based on the "tread width" and "tire width (front/rear)" in the specification table. The "tire outer width" can be calculated as the tread width plus the maximum value of the front/rear tire width.

In S2, the controller 21 of the information processing apparatus 20 accepts questions in natural language. In this embodiment, the question is input to the external device 30. The question may be input as voice or as text. For example, the question may be the voice recorded during a business negotiation via a microphone or similar device as the input interface of the external device 30, or text written by staff during the negotiation via a keyboard or touch screen as the input interface of the external device 30. The external device 30 sends the input question to the information processing apparatus 20. The controller 21 of the information processing apparatus 20 receives the question sent from the external device 30 via the communication interface 23. The controller 21 analyzes the received question. For the analysis of the question, any method such as morphological analysis, syntactic analysis, or semantic analysis can be used, for example.

In S3, the controller 21 of the information processing apparatus 20 identifies the search conditions indicated by the question using machine learning. Specifically, the controller 21 extracts one or more keywords to define the specifications of the vehicle as the search conditions. The controller 21 extracts the vehicle attributes, reference values associated with the attributes, and comparison conditions as one or more keywords. Examples of keywords extracted as "vehicle attributes" include, for example, "vehicle height", "tire outer width", and "tread width". Keywords extracted as "reference values" are any numerical values. Examples of keywords extracted as "comparison conditions" include "equal", "not equal", "greater than or equal to", "less than or equal to", "less than", etc.

In S4, the controller 21 of the information processing apparatus 20 adjusts the reference value based on the attributes associated with the extracted reference value. Specifically, the controller 21 determines whether the extracted reference value has a unit, and if it determines that there is no unit, estimates the unit of the reference value based on the attribute and the number of digits of the reference value. For example, when the attribute is "vehicle height" and the reference value has four digits, the controller 21 estimates its unit as [mm], and when the reference value has one digit, it estimates its unit as [m]. Here, the number of digits refers to the number of digits excluding the decimal point. As an example, in S2, a question sentence "Please tell me the vehicle with a height of 1.55 or less" is inputted. Here, the term "example" is not intended to limit the present disclosure, but rather to aid in understanding of the present embodiment. In this case, the controller 21 of the information processing apparatus 20 extracts the keywords "vehicle height", "1.55", and "or less" as search conditions, along with the vehicle's attributes and the reference values associated with those attributes, and the comparison conditions with the reference values in S3. Here, "1.55" is extracted as the reference value associated with the attribute "vehicle height". In this case, the controller 21 determines that the number of digits of the reference value "1.55" is 1 digit by truncating the decimal part, and estimates the unit of the reference value "1.55" to be "m". Alternatively, in S2, a question sentence "Please tell me the vehicle with a height of 1550 or less" is inputted. In this case, the controller 21 of the information processing apparatus 20 extracts the keywords "vehicle height", "1550", and "or less" as search conditions, along with the vehicle's attributes and the reference values associated with those attributes, and the comparison conditions with the reference values in S3. Here, "1550" is extracted as the reference value associated with the attribute "vehicle height". In this case, the controller 21 determines that the number of digits of the reference value is 4 digits and estimates the unit of the reference value "1550" to be "mm".

As a variation of the present embodiment, the controller 21 of the information processing apparatus 20 may convert the unit of the reference value to the unit registered in the database DB. Specifically, it is assumed that the attribute value for "vehicle height" is registered in meters in the database DB, and that the unit of the reference value estimated in S4 is "mm". In this case, the controller 21 may convert the reference value to meters. For example, the controller 21 may convert the reference value "1550mm" to "1.55m".

In S5, the controller 21 of the information processing apparatus 20 generates a query to select vehicles that meet the identified search conditions from the database DB. Specifically, the controller 21 generates an SQL query for the database DB based on the search conditions identified in S3 and the adjusted reference value in S4. "SQL" is an abbreviation for Structured Query Language. For example, in S3, the keywords "vehicle height" (vehicle attribute), "1.55" (reference value), and "or less" (comparison condition with the reference value) are extracted, and in S4, the reference value "1.55" is adjusted to "1.55m". In this case, the controller 21 generates a query meaning "Select vehicles from the database DB that have a height of 1.55m or less."

In S6, the controller 21 of the information processing apparatus 20 searches the database DB using the query generated in S5. Specifically, the controller 21 executes the query generated in S5 against the database DB and retrieves the data D1 of the vehicles that match the query. Data D1 includes information indicating the vehicle types of one or more vehicles that match the search criteria. Data D1 may also include information indicating the model year, price, mileage, etc., of each vehicle.

In S7, the controller 21 of the information processing apparatus 20 outputs the search results of the database DB based on the query. Specifically, the controller 21 performs control to display the data D1 acquired in S6 on the external device 30. Data D1 may be displayed by any procedure, such as the following procedure. The controller 21 acquires a set of data matching the query from the database DB as data D1. The controller 21 transmits data D1 to the external device 30 via the communication interface 23. The external device 30 receives the data D1 sent from the information processing apparatus 20 and displays the search results indicated by data D1 on a display or the like as an output interface. The controller 21 may input the question sentence received in S2 and the data D1 obtained in S5 into a large language model to obtain a natural language response and output this response.

According to the present embodiment, even when the unit of the numerical reference value included in the question sentence is unclear, it is possible to automatically generate the correct search condition expression when inquiring about products corresponding to specific specifications using a natural language question sentence. Therefore, the technology for searching products that correspond to specific specifications from natural language question sentences is improved.

In this embodiment, the external device 30 is installed outside the information processing apparatus 20, and it has been described that the information processing apparatus 20 and the external device 30 perform processing while transmitting and receiving various data via the network 40, but some or all of the functions of the information processing apparatus 20 may be mounted on the external device 30.

In this embodiment, when the controller 21 identifies the search conditions in S3 and determines that the unit of the reference value is clear, it may omit the processing in S4. Alternatively, even when the unit of the reference value is clear when identifying the search conditions in S3, the controller 21 may refer to the database DB in S4 and confirm the values and/or units registered for the attributes associated with the reference value, thereby correcting the numerical value or unit of the reference value included in the question sentence. For example, if a user mistakenly says "1.55 millimeters" instead of "1.55 meters" as a reference value for the attribute "vehicle height," the controller 21 detects the unnatural change in unit by referring to the database DB and confirming the registered values for "vehicle height." According to this configuration, it is possible to correct errors in numerical units due to misstatements or input mistakes. When a numerical unit error is detected, the controller 21 may perform control to display a prompt asking the user for confirmation. For example, the controller 21 may perform control to display a message on the external device 30 saying, "Is it 1.55 meters, not 1.55 millimeters?"

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

1. An information processing apparatus comprising a controller configured to:
register, for a plurality of vehicles, one or more attributes in a database in combination with attribute values that are values of the attributes;
identify, when a question sentence in natural language is input, a search condition indicated in the question sentence in relation to the attributes using machine learning;
generate a query to select a vehicle corresponding to the identified search condition from the database; and
perform control to output a result of searching the database using the query.

2. The information processing apparatus according to claim 1, wherein
the one or more attributes include specifications of an automobile, and
the controller is configured to extract one or more keywords to define the specifications as the search condition.

3. The information processing apparatus according to claim 2, wherein
the controller is configured to extract an attribute of a vehicle, a reference value associated with the attribute, and a condition for comparison with the reference value, as the one or more keywords, and
the controller is configured to adjust the extracted reference value based on an attribute associated with the reference value.

4. The information processing apparatus according to claim 3, wherein the controller is configured to determine whether the extracted reference value has a unit, and, upon determining that the extracted reference value has no unit, estimate a unit of the reference value based on the attribute and a number of digits of the reference value.

5. The information processing apparatus according to claim 3, wherein the controller is configured to convert a unit of the reference value to a unit registered in the database.
